(19) United States
(12) Patent Application Publication
(10) Pub. No.: US 2006/0190629 A1
(43) Pub. Date: Aug. 24, 2006

(54) Method of automatically selecting channel to receive stream transmitted in IEEE 1394 network

(75) Inventors: Chul-Seung Kim, Suwon-si (KR); Young-Seop Han, Suwon-si (KR); Yun-Je Oh, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD.

(21) Appl. No.: 11/357,545

(22) Filed: Feb. 17, 2006

(30) Foreign Application Priority Data
Feb. 18, 2005 (KR) 2005-13610

(51) Int. Cl. G06F 3/00; G06F 5/00

(52) U.S. Cl. 710/1; 710/52

(57) ABSTRACT

A method and system of automatically selecting a channel to receive a stream transmitted in an IEEE 1394 network is provided. The method and system include the steps of: a predetermined IEEE 1394 device belonging to the IEEE 1394 network, selecting a predetermined channel number by changing the channel number of a current channel; reading a value input through a channel having the predetermined channel number and stored in a data buffer and storing the read value as a first variable; reading a value input through the channel having the predetermined channel number and stored in the data buffer and storing the read value as a second variable; comparing the first variable to the second variable; and selecting the predetermined channel number if the first variable and the second variable are different from each other as the comparison result.

### CLAIM OF PRIORITY

This application claims priority under 35 U.S.C. § 119 to an application entitled “Method of Automatically Selecting Channel to Receive Stream Transmitted in IEEE 1394 Network,” filed in the Korean Intellectual Property Office on Feb. 18, 2005 and assigned Serial No. 2005-13610, the contents of which are incorporated herein by reference.

### BACKGROUND OF THE INVENTION

1. Field of the Invention

The present invention relates generally to an IEEE 1394 network, and in particular, to a method of selecting a channel through which a stream is being transmitted in an IEEE 1394 network.

2. Description of the Related Art

IEEE 1394 networks offer high-speed access through the serial input/output bus of computer peripherals and other electronic devices, offering high-speed communications and isochronous real-time data services. An IEEE 1394 bus may accommodate up to 63 devices. In an IEEE 1394 network, devices are organized on a bus in a tree topology whereas each device is assigned a unique self-id and one of the nodes is elected root node. In a conventional IEEE 1394 network, when each node transmits an isochronous stream of data in an IEEE 1394 network, the node must acquire a channel for the stream transmission through an isochronous resource manager (IRM) and have a bandwidth of a bus allocated to it.

Hereafter, the structure and operation of the conventional node area of the IRM and conventional method of checking a channel through which a stream is being transmitted is described in reference to FIGS. 1-4, and 6.

FIG. 1 is an illustration of a portion of a node area of the IRM used in the IEEE 1394 network according to the prior art.

FIG. 1 illustrates the locations of a “CHANNELS_AVAILABLE” register 103 for determining whether a channel is occupied and a “BANDWIDTH_AVAILABLE” register 102 for bandwidth allocation in the node area of the IRM.

As illustrated in FIG. 1, the node area of the IRM occupies 2 KB including 512 Byte for a control and status register (CSR) design area 11, 512 Byte for a serial bus area 12, and 1 KB for a Read Only Memory (ROM) area 13. The serial bus area 12 includes the “CHANNELS_AVAILABLE” register 103 for determining whether a channel is occupied and the “BANDWIDTH_AVAILABLE” register 102 for bandwidth allocation.

That is, the “BANDWIDTH_AVAILABLE” register 102 is mapped to a location of an offset 220h from the beginning address of the serial bus area 12, and the “CHANNELS_AVAILABLE” register 103 is mapped to a location of an offset 224h from the beginning address.

When a predetermined node in the IEEE 1394 network accesses the IEEE 1394 network using the registers described above in order to obtain isochronous resources, the predetermined node performs a lock transaction.

FIG. 2 is a signaling diagram illustrating the lock transaction used in the IEEE 1394 network according to the prior art.

As illustrated in FIG. 2, the lock transaction used in the IEEE 1394 network is achieved by communication between a requester node including a requester transaction layer 21 and a requester link layer 22 and a responder node including a responder link layer 23 and a responder transaction layer 24.

When a lock request is input to the requester transaction layer 21 in step 210, the requester transaction layer 21 transmits a data packet request to the requester link layer 22 in step 211.

Then, the requester link layer 22 transmits a data packet to the responder link layer 23 in step 212, and the responder link layer 23 transmits a data packet indication to the responder transaction layer 24 in step 213. By doing this, the responder transaction layer 24 recognizes a lock indication in step 220. In response to steps 210 to 213, a data packet response in step 221, an acknowledge in step 222, and a data packet confirmation in step 223 are transmitted in the reverse order.

When a lock response is input to the responder transaction layer 24 in step 230, the responder transaction layer 24 transmits a data packet request to the responder link layer 23 in step 231.

Then, the responder link layer 23 transmits a data packet to the requester link layer 22 in step 232, and the requester link layer 22 transmits a data packet indication to the requester transaction layer 21 in step 233. By doing this, the requester transaction layer 21 recognizes a lock confirmation in step 240. In response to steps 230 to 233, a data packet response in step 241, an acknowledge in step 242, and a data packet confirmation in step 243 are transmitted in the reverse order.

FIG. 3 is a further illustration of a structure of the “CHANNELS_AVAILABLE,” presented in FIG. I which is a register used for channel allocation in the node area of the IRM used in the IEEE 1394 network according to the prior art.

As illustrated in FIG. 3, the register contains information on 64 channels and is classified into a high format register 31 containing information on a “0” channel to a “31” channel and a low format register 32 containing information on a “32” channel to a “63” channel.

In an initialization stage, all bits are set to ‘1’ indicating that all channels are not allocated.

Each node in the IEEE 1394 network first checks a current register value in order to determine whether an isochronous channel is allocated or whether transmission through the allocated isochronous channel is proceeding. If no channel is allocated because the “CHANNELS_AVAILABLE” register 103 is initialized with all bits set to 1, each node makes a request for an available channel using the lock transaction.

FIG. 4 is a diagram illustrating the channel allocation process using lock transaction performed by a predetermined node in the IEEE 1394 network according to the prior art.

FIG. 4 illustrates the channel allocation process using lock transaction based on the assumption that no channel is allocated. That is, the predetermined node requesting a channel number allocated to it, reads the data value 41 of the “CHANNELS_AVAILABLE” register 103 and knows that no channel is allocated yet. Herein, if possible, a value ‘FFFF FFFFh’ is transmitted to the IRM using a lock request packet.

If the new data value 42, containing a new bit value is stored in the “CHANNELS_AVAILABLE” register 103, the predetermined node is informed using lock transaction indicating that a channel “0” (FFFF FFFE) is successfully allocated to the predetermined node. However, if the data value 41 received through the lock transaction is compared to a data value 43 stored in the “CHANNELS_AVAILABLE” register 103, which has been read before the lock transaction, and the data values 41 and 43 are the same as the comparison result, the predetermined node cannot have a channel allocated to it.

FIG. 6 is a flowchart of a method of checking a channel through which a stream is being transmitted in the IEEE 1394 network according to the prior art.

As illustrated previously in FIG. 4, when the predetermined node wants to have a channel allocated to it and receive a stream to be transmitted, the predetermined node must know a channel number in advance through an agreement with a transmission node or confirm a channel number by accessing the IRM and reading a data value of the “CHANNELS_AVAILABLE” register 103. In the general, the predetermined node checks whether a specific channel is being used for transmission in order to receive a stream through the specific channel, which is determined by accessing the IRM and reading a data value of the “CHANNELS_AVAILABLE” register 103.

Hereafter described is the conventional method of determining whether a channel is being used for transmission, when a predetermined node checks whether a specific channel is being used for transmission, in order to receive a stream through the specific channel. This method uses a process of accessing the IRM and reading a data value of the “CHANNELS_AVAILABLE” register 103 in use.

Referring to FIG. 6, in step 61, a predetermined node selects a specific channel. After determining that the specific channel identified by a selected channel number is not available, the proposed channel to be checked is selected by sequentially increasing or decreasing the selected channel number in step 61.

If the selected channel number is equal to or less than 31 in step 62, the high format register 31 of the “CHANNELS_AVAILABLE” register 103 is checked in step 63. If the selected channel number is greater than 31 in step 62, the low format register 32 of the “CHANNELS_AVAILABLE” register 103 is checked in step 64.

In the both cases, to check the “CHANNELS_AVAILABLE” register 103 of the IRM, an operation implemented according to “read request” of the lock transaction is performed. Since the operation implemented according to “read request” is performed by transmitting a packet to the IRM, a response time is determined according to a state of the IRM or a state of an IEEE 1394 topology.

In step 65, it is determined whether the selected channel is being used by checking data provided from a response from the IRM. If the response indicates that the selected channel is being used, the predetermined node receives a stream transmitted through the selected channel by selecting a channel number of the selected channel in step 66, and if the selected channel is not being used, this process proceeds to step 61 to determining whether a channel having an increased or decreased channel number is being used through the IRM.

Since a stream data may not be transmitted regardless of whether the selected channel is registered in the IRM for the use, verification is necessary.

As described above, in the conventional method, when a predetermined node wants to sequentially or automatically search for a channel in order to receive isochronous data to know whether a channel is currently used requires that the predetermined node request for and read the “CHANNELS_AVAILABLE” register 103 of the IRM through the lock transaction and determine whether the found channel is being used.

Therefore, the time required to check the status of a channel is affected according to the state of the IRM, a state of the IEEE 1394 network topology, and start and end timings of a stream.

Moreover, if other nodes have channels or bandwidths allocated to them by accessing the IRM through the lock transaction, the predetermined node cannot access the “CHANNELS_AVAILABLE” register 103 of the IRM and must wait until any other node finishes its operation.

In addition, the “CHANNELS_AVAILABLE” register 103 is read from the IRM and stored to use channel information several times. In this case, since a channel state is unstable due to the transmission characteristics of the IEEE 1394 topology and the isochronous stream, even if it can be determined that a channel of the IRM is currently used, it cannot be guaranteed to receive a stream through the currently used channel.

### SUMMARY OF THE INVENTION

An aspect of the present invention is to provide a method of automatically selecting a channel to receive a stream transmitted in an IEEE 1394 network, in which the channel checking time can be reduced by each node checking a channel using a data buffer.

According to one embodiment of the present invention, there is provided a method of automatically selecting a channel to receive a stream transmitted in an IEEE 1394 network, the method comprising the steps of: attaching a predetermined IEEE 1394 device belonging to the IEEE 1394 network, selecting a predetermined channel number by changing the channel number of a current channel; reading a value input through a channel having the predetermined channel number and stored in a data buffer and storing the read value as a first variable; reading a value input through the channel having the predetermined channel number and stored in the data buffer and storing the read value as a second variable; comparing the first variable to the second variable; and selecting the predetermined channel number if the first variable and the second variable are different from each other as the comparison result.

### BRIEF DESCRIPTION OF THE DRAWINGS

The above features and advantages of the present invention will become more apparent from the following detailed description when taken in conjunction with the accompanying drawings in which:

FIG. 1 is an illustration of a portion of a node area of an IRM used in an IEEE 1394 network according to the prior art;

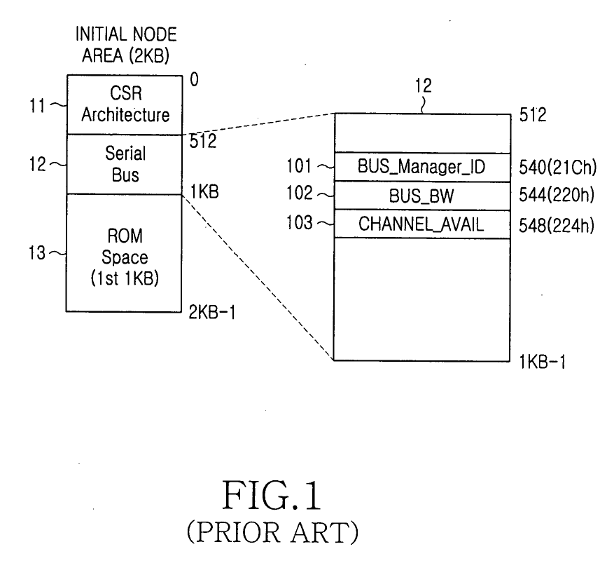

FIG. 2 is a signaling diagram illustrating a lock transaction used in the IEEE 1394 network according to the prior art;

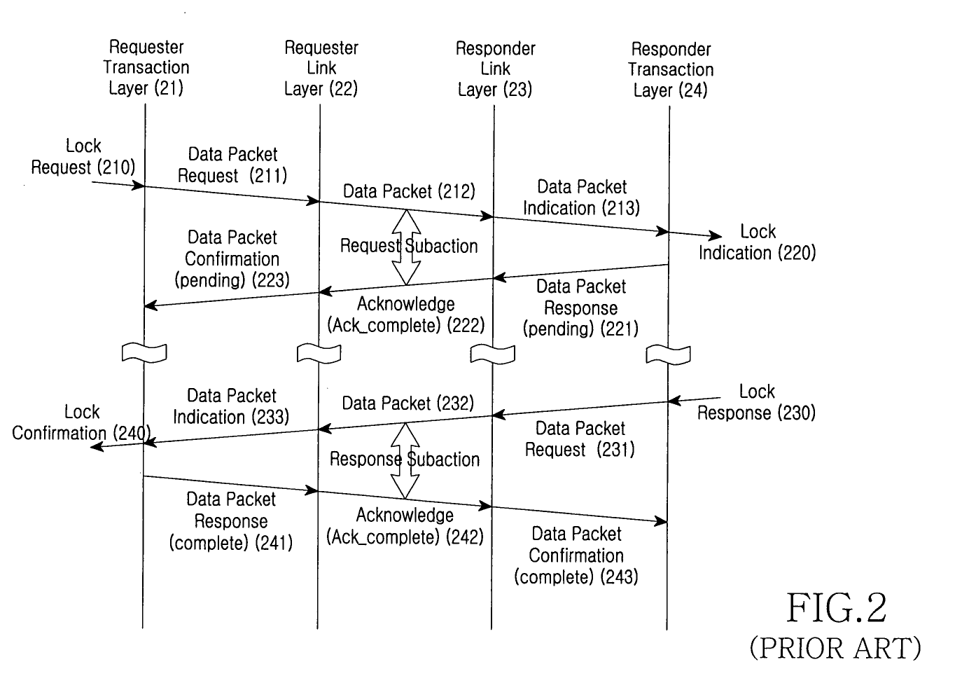

FIG. 3 is a further illustration of the structure of the “CHANNELS_AVAILABLE,” presented in FIG. 1 which is a register used for channel allocation in the node area of the IRM used in the IEEE 1394 network according to the prior art;

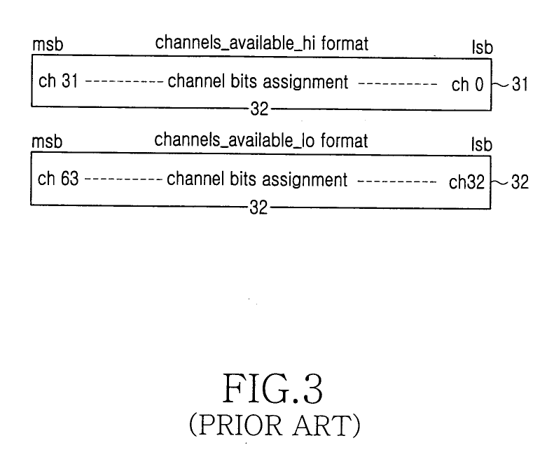

FIG. 4 is a diagram illustrating the channel allocation process using lock transaction performed by a predetermined node in the IEEE 1394 network according to the prior art;

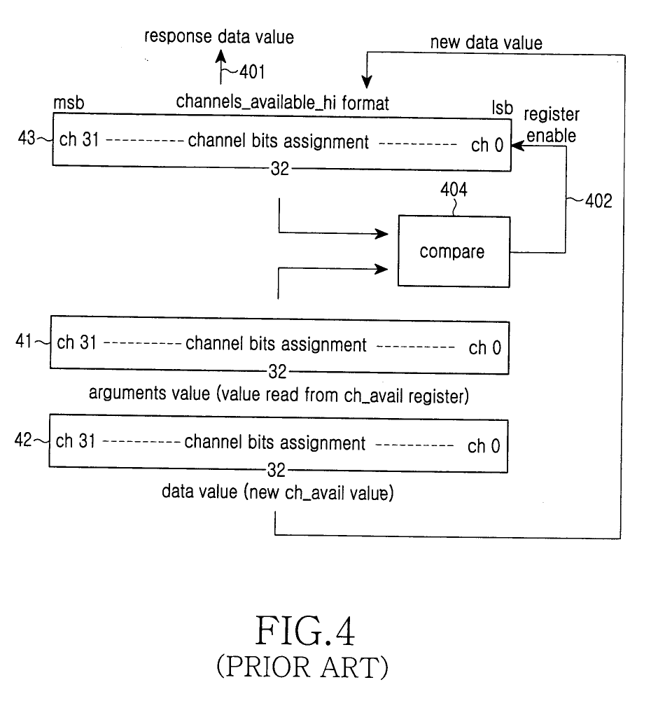

FIG. 5 is a block diagram of an IEEE 1394 device of each node in the IEEE 1394 network, according to a preferred embodiment of the present invention;

FIG. 6 is a flowchart of a method of checking a channel through which a stream is being transmitted in the IEEE 1394 network, according to the prior art; and

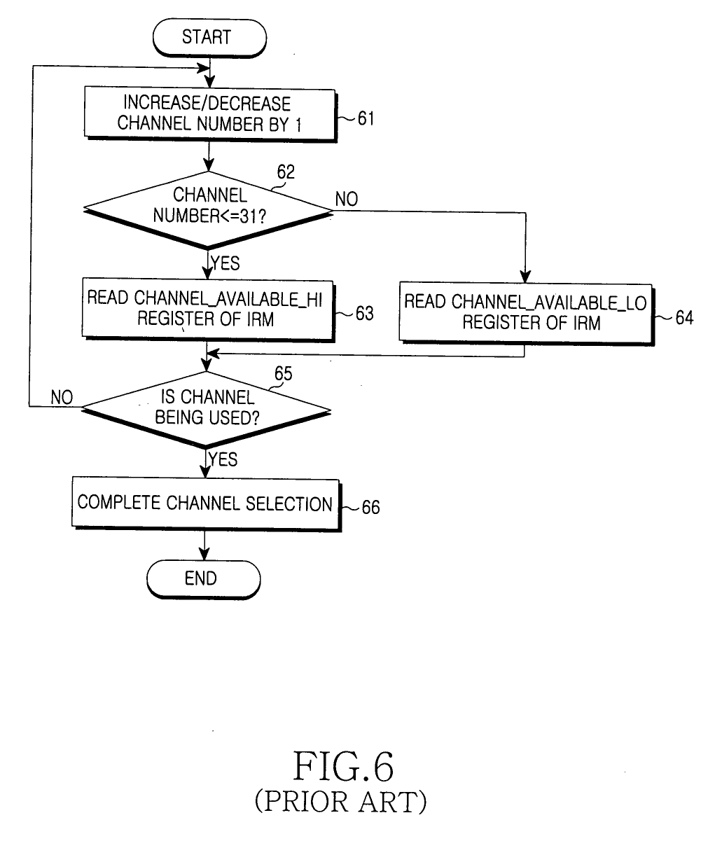

FIG. 7 is a flowchart of a method of automatically selecting a channel to receive a stream transmitted in the IEEE 1394 network, according to a preferred embodiment of the present invention.

### DETAILED DESCRIPTION

Hereinafter, embodiments of the present invention will be described in detail with reference to the accompanying drawings. For the purposes of clarity and simplicity, a detailed description of known functions and configurations incorporated herein will be omitted as it may make the subject matter of the present invention unclear.

The structure and operation of an IEEE 1394 device of each node in the IEEE 1394 network will be described according to a preferred embodiment of the present invention.

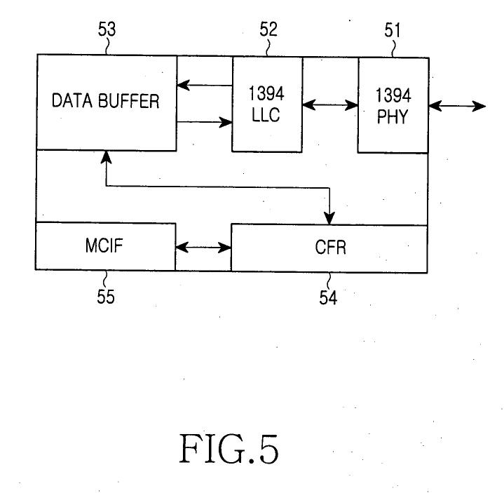

FIG. 5 is a block diagram of an IEEE 1394 device of each node in the IEEE 1394 network, according to a preferred embodiment of the present invention.

As illustrated in FIG. 5, the IEEE 1394 device includes an IEEE 1394 physical unit (PHY) 51, an IEEE 1394 logical link controller (LLC) 52 for an IEEE 1394 connection, a data buffer 53 for temporarily storing a stream transmitted from an external interface (an IEEE 1394 PHY and an IEEE 1394 LLC) connected to the IEEE 1394 LLC 52, a configuration register (CFR) 54 connected to the data buffer 53 and used to access the data buffer 53, and a controller (MCIF) 55 connected to the CFR 54 and controlling the access to the data buffer 53.

Operationally, the IEEE 1394 device is connected to an external device through the IEEE 1394 PHY 51 and the IEEE 1394 LLC 52. Then, the data buffer 53 stores a stream transmitted from the external device through the IEEE 1394 PHY 51 and the IEEE 1394 LLC 52, and the stored stream is broadcasted/unicasted through the IEEE 1394 PHY 51 and the IEEE 1394 LLC 52 again using the IEEE 1394 topology.

The CFR 54 is used to access the data buffer 53 and read the contents stored in the data buffer 53, and detailed information of a variety of categories of data is contained in the CFR 54 and is different according to a given IEEE 1394 element. The IEEE 1394 element refers to the variety of chips available from different manufactures and models which contain different information and categories of data in the CFR 54. The MCIF 55 controls the IEEE 1394 PHY 51 and the IEEE 1394 LLC 52 regardless of kinds of the IEEE 1394 element, and in the current embodiment, the MCIF 55, in firmware, reads the state of the data buffer 53 via the CFR 54 category and then after a predetermined time, reads the state of the data buffer 53 via the CFR 54; the firmware then compares the values in the category.

The IEEE 1394 device according to the current embodiment receives an isochronous stream transmitted through a specific channel via the IEEE 1394 PHY 51 and IEEE 1394 LLC 52, stores the isochronous stream in the data buffer 53 for a predetermined time and reproduces the received isochronous stream. The isochronous stream is transmitted to the external device through the IEEE 1394 PHY 51 and IEEE 1394 LLC 52 if the isochronous stream is written in the data buffer after setting up the category of the buffer in the CFR. The stored isochronous stream can be read by the MCIF or another interface (such as a video out). For example, an IEEE 1394 device, such as a video cassette recorder, confirms and reproduces an isochronous stream being transmitted in the IEEE 1394 network.

Furthermore, the IEEE 1394 device according to the current embodiment, performs a channel search using the data buffer 53 which temporarily stores isochronous data in the IEEE 1394 device without using the IRM. Each node in the IEEE 1394 network searches for a different channel according to a user's request, each node confirms a channel through which a stream is being transmitted among currently used channels out of the 64 channels available and reproduces the stream. Therefore, the current embodiment is superior to the prior art in that searching time is shorter since each node does not accesses the IRM and searches for a currently used channel through a lock transaction and a read transaction as in the conventional method.

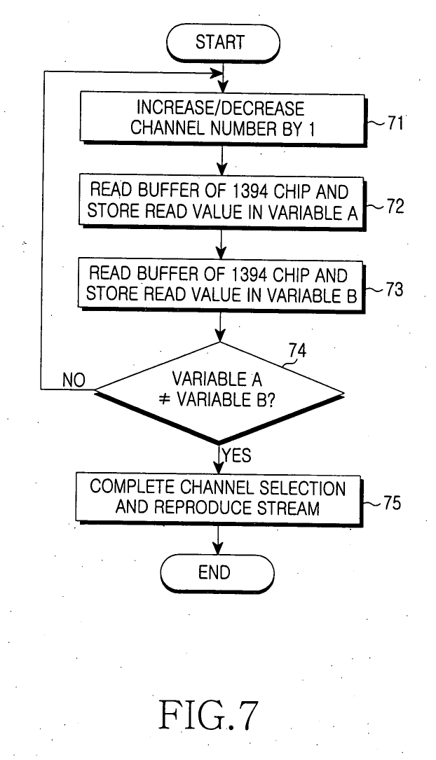

The transmission of the isochronous data in the current embodiment is achieved using 64 channels of 0^{th} to 63^{rd} channels as found in the current IEEE 1394 technology. If the role of home networks increases and other devices transmitting IEEE 1394 streams are introduced in the future the number of channels provide in the IEEE 1994 technology will increase. The present embodiment would enhance an IEEE 1394 technology because of its shorten channel searching time. Hereafter, the method of automatically selecting a channel to receive a stream transmitted in the IEEE 1394 network will be described in reference to FIGS. 5 and 7 according to the preferred embodiment of the present invention.

FIG. 7 is a flowchart of a method of automatically selecting a channel to receive a stream transmitted in the IEEE 1394 network, according to a preferred embodiment of the present invention.

As illustrated in FIG. 7, in step 71, a channel is temporarily selected by increasing or decreasing a channel number of a currently used channel by 1, and a stream is received through the temporarily selected channel. As a reference, since a 31^{st} channel of the total channels is generally set to transmit an async stream in the IEEE 1394 network, the 31^{st} channel is dealt with as an exception in the channel selection. This exceptional channel is not limited to the 31^{st} channel but can vary according to settings of the IEEE 1394 network.

When a channel is temporarily selected and a stream is received through the temporarily selected channel, the received stream data is stored in the data buffer 53 of the IEEE 1394 device in FIG. 5. According to the current embodiment, in step 72, the MCIF 55 accesses the data buffer 53 of the IEEE 1394 device, reads the stream data stored in the data buffer 53, and stores the read stream data in a variable A. After a predetermined time, in step 73, the MCIF 55 accesses the data buffer 53 of the IEEE 1394 device, reads stream data stored in the data buffer 53, and stores the read stream data in a variable B. In step 74, a value of the variable A and a value of the variable B are compared to each other in order to determine whether a stream is being transmitted through the temporarily selected channel.

That is, it can be determined that a stream is not being transmitted through the temporarily selected channel if stream data having a time difference are read and the read stream data values are the same. In other words, since a value of stream data stored in the data buffer 53 continuously varies if a stream is being transmitted and stored in the data buffer 53, the value of the variable A and the value of the variable B must be different if a stream is being transmitted.

Thus, if the value of the variable A and the value of the variable B are different from each other as the comparison result, a stream is currently being transmitted through the temporarily selected channel. Thus, in step 75, the temporarily selected channel is selected as a channel for the stream reception, and the stream is reproduced. If the value of the variable A and the value of the variable B are the same as the comparison result, a stream is not currently being transmitted through the temporarily selected channel. Thus, this process repeats steps 71 to 74.

The method of the present invention can be written as computer programs and can be stored in a computer readable recording medium (CD-ROM, RAM, floppy disks, hard disks, optical magnetic disks, etc.). The present embodiment is not limited to the current state of art in storage media or a specific computer language.

As described above, according to the embodiments of the present invention, since each node searches for a channel by selecting a temporary channel and checking the variation of a value of a temporarily stored isochronous stream using the characteristic that an isochronous stream is temporarily stored in an IEEE 1394 device, it is unnecessary to perform transactions for channel allocation through an IRM. Thus, the channel selection can be performed more quickly and accurately since the channel selection is not affected by states of other IEEE 1394 nodes and the IEEE 1394 topology.

While the embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A method of automatically selecting a channel to receive a stream transmitted in an IEEE 1394 network, the method comprising the steps of:
(a) a predetermined IEEE 1394 device belonging to the IEEE 1394 network, selecting a predetermined channel number by changing the channel number of a current channel;
(b) reading a first value input through a channel having the predetermined channel number and stored in a data buffer and storing the first read value as a first variable;
(c) reading a second value input through the channel having the predetermined channel number and stored in the data buffer and storing the second read value as a second variable;
(d) comparing the first variable to the second variable; and
(e) selecting the predetermined channel number if the first variable and the second variable are different from each other according to the comparison result.

2. The method of claim 1, further comprising (f) if the first variable and the second variable are the same in step (d), changing the predetermined channel number and proceeding steps (b) to (e).

3. The method of claim 1, wherein when a channel is selected in step (a), the 31^{st} channel is not selected.

4. The method of claim 1, wherein the data buffer is a device, which stores a stream transmitted through an external interface, in the IEEE 1394 device.

5. A system for automatically selecting a channel to receive a stream transmitted in an IEEE 1394, said system comprising:
a memory for storing a computer-readable code; and,
a processor operatively coupled to said memory, said processor configured to:
(a) select, by a predetermined IEEE 1394 device belonging to the IEEE 1394 network, a predetermined channel number by changing the channel number of a current channel;
(b) read a first value input through a channel having the predetermined channel number and stored in a data buffer and store the first read value as a first variable;
(c) delay for a predetermined amount of time;
(d) read a second value input through the channel having the predetermined channel number and stored in the data buffer and storing the second read value as a second variable;
(e) compare the first variable to the second variable; and
(f) select the predetermined channel number if the first variable and the second variable are different from each other according to the comparison result.

6. The system in claim 5, wherein the number of a predetermined channel number is at least 64.
